(19) United States
(12) Patent Application Publication
(10) Pub. No.: US 2026/0087485 A1
(43) Pub. Date: Mar. 26, 2026

(54) CRYPTOGRAPHIC IMPROVEMENTS TO CELLULAR DATA TRANSFER UTILIZING BLOCKCHAIN WALLETS

(71) Applicant: DJ3N, LLC, Sheridan, WY (US)

(72) Inventors: Edward Atter, Philadelphia, PA (US); Adrian Robison, Los Angeles, CA (US); Demetre Gostas, Laramie, WY (US)

(21) Appl. No.: 19/409,337

(22) Filed: Dec. 4, 2025

Related U.S. Application Data
(63) Continuation-in-part of application No. 18/499,067, filed on Oct. 31, 2023.
(60) Provisional application No. 63/420,892, filed on Oct. 31, 2022.

(51) Int. Cl. G06Q 20/36; G06K 19/06; G06Q 20/38

(52) U.S. Cl. CPC G06Q 20/36; G06Q 20/3829; G06Q 20/389; G06K 19/06037

(57) ABSTRACT

There is disclosed a novel method and apparatus for securing and accessing an SMS wallet.

### RELATED APPLICATION INFORMATION

This application is a continuation-in-part of application Ser. No. 18/499,067, filed Oct. 31, 2023 entitled “CRYPTOGRAPHIC IMPROVEMENTS TO CELLULAR DATA TRANSFER UTILIZING BLOCKCHAIN WALLETS,” which claims the benefit of Application No. 63/420,892 filed Oct. 31, 2022 entitled “CRYPTOGRAPHIC SYSTEM FOR ROYALTY AND INFORMATION DISTRIBUTION” all of which are hereby incorporated by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records but otherwise reserves all copyright and trade dress rights whatsoever.

### BACKGROUND

### Field

This disclosure relates to improvements to networking systems. More specifically there is disclosed a system, method of making, and apparatus for distributing tickets to a user's SMS wallet. Unlike other cryptographic wallets that require a user retain access to their own private keys, or relies solely on a third party for access, the present disclosure allows a user to store cryptographic keys on a user device in areas not traditionally associated with storing private keys (an image file on a device, cookie, or data on a keyring) while verifying it is the user trying to restore an SMS wallet by requesting cryptographic keys or at least a portion thereof from a third party server disconnected from the user's device.

### Description of the Related Art

Cryptographic wallets have become ubiquitous but still have multiple security flaws. For one if a user forgets their seed phrase, they may lose access to the wallet entirely. If a user trusts a third party to have total access to the user's wallet, the user risks the third party being attacked by a malicious actor and giving access to the wallet to the bad actor. There needs to be a system in which a user can secure an SMS wallet even if a malicious actor compromises a user's device and a third party server. The present disclosure deals with this problem.

### DESCRIPTION OF THE DRAWINGS

FIG. 1 is an overview of a potential apparatus and process of securely sending the SMS wallet.

FIG. 2 is a drawing of an apparatus for securely distributing and recovering a wallet from a blockchain network via a cellular network.

FIG. 3 shows a potential apparatus that can be used to generate and interact with an SMS wallet.

FIG. 4 shows an embodiment of creating a wallet using a user device.

FIG. 5 shows an embodiment of restoring a wallet using a user device.

FIG. 6 shows a different potential setup of an SMS wallet.

FIG. 7 shows a list of functions an SMS wallet is capable of.

FIG. 8 shows a potential ranking system that can be used with data provided by users which SMS wallets have been distributed to.

FIG. 9 shows some example QR codes that contain a private key and/or data stored on a user device.

### DETAILED DESCRIPTION

The present disclosure offers several improvements over conventional methods of distributing data over blockchain networks via a wallet. First, the present disclosure teaches a shared custody wallet in which the cryptographic keys used to generate the wallet may be stored with both the individual user, and secure third party platforms (third party servers). Second, the cryptographic keys may be generated on a client side processor within a browser. This means no sensitive data used to produce the keys is ever sent to another server during the wallet's generation which results in less opportunity for a hacker to steal sensitive data. The third stems from the first in that 2FA authentication may be used in addition to the present disclosure which means there are two levels of authentication as opposed to only one. 2FA authentication may require a side-channel communication device in order to unlock the wallet. The addition of 2FA offers an additional level of authentication.

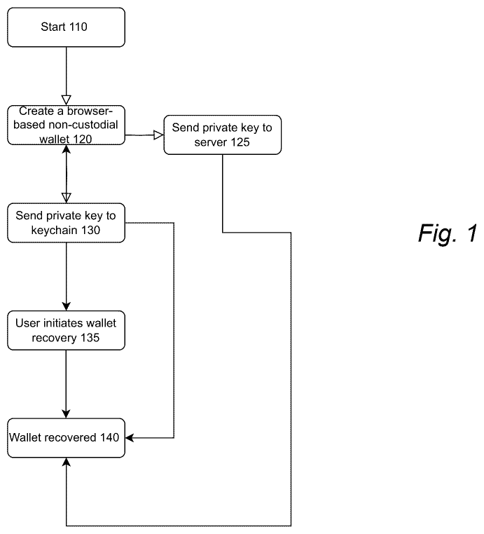

Turning to FIG. 1 there is an overview of a potential apparatus and process of securely sending the SMS wallet. At 110 the user starts a program running on a mobile device. The mobile device can be a smartphone with a cellular connection. The mobile device should also be associated with a unique SMS number. An SMS number, commonly known as a “text-enabled phone number” or “SMS-enabled phone number,” is a phone number that is capable of sending and receiving SMS (Short Message Service) text messages. SMS is a common messaging service that allows users to send short text messages from one mobile device to another. SMS numbers can be regular phone numbers associated with mobile devices or virtual phone numbers provided by SMS service providers.

At 120 a user may use a web browser on the mobile device to generate a browser based non-custodial wallet. For conventional blockchain wallets, the main difference between a custodial wallet and a noncustodial wallet lies in what user has control over the private keys and the funds stored in the wallet. A private key is a confidential cryptographic credential that grants authoritative control over a blockchain-based wallet and the digital assets stored within it.

For custodial wallets a third party, such as an exchange or a service provider, holds and manages private cryptographic keys and cryptocurrency funds on a user's behalf. A user typically creates an account with the custodial service, and the custodial service generates and controls the private keys for the user's wallet. The service provider has access to the user's funds and can facilitate transactions and account management on the user's behalf. For purposes of this disclosure an SMS wallet is a cryptographic in which an SMS number is used in part to generate the wallet. This can be from the SMS number itself being run through a hashing algorithm used to generate the private keys of the SMS wallet.

Although custodial wallets are generally user-friendly and convenient, a user must rely on the security and trustworthiness of a custodial service. This necessitates relying on another third party user which introduces a potential vector of attack for malicious software or a user stealing funds from a wallet.

For a noncustodial wallet, a user has full control over their own private keys and cryptocurrency funds. The wallet software, whether it's a software wallet, hardware wallet, or paper wallet, generates and stores private keys on a user's device. The drawback with a noncustodial wallet is if a user loses the keys the wallet cannot be opened. Additionally, if a malicious actor captures the user's keys, they can access the wallet and exclude the user from funds.

Noncustodial wallets are considered more secure from a user control perspective, as a user is not dependent on the security practices or trustworthiness of a third party. However, a wallet may be less user-friendly and require a user to be vigilant about protecting a user's private keys.

At 120 a user creates a non-custodial wallet. The non-custodial wallet is generated from a processor executing instructions fetched from a browser. The browser may be used to access a website wherein a wallet is based. The browser may also work with a plugin that accesses a secure wallet. Such wallets include the DJ3N plugin and the MetaMask plugin and Brave crypto wallet.

An example of a potential apparatus is described below. The SMS Wallet is a lightweight non-custodial wallet solution for users to quickly create a wallet bound to their phone number, receive (or purchase) inexpensive NFTs, showcase their NFTs, and to hold a small amount of crypto assets. The wallet primarily operates on a mobile browser, and is recoverable using text message verification codes in combination with a QR code saved by the user during the wallet's creation.

Once created, some operations for the wallet may also be completed by text message commands. These operations allow NFTs to be minted on or transferred to the user's SMS wallet. The wallet may also allow the user to give the operator (a server) the custody over some assets for specific purposes, such as transferring native assets or NFTs to specific addresses. This expands the scope of actions that can be completed solely with text messages commands.

The SMS wallet may also allow a user to directly purchase NFTs using credit cards, or claim NFTs for free in some instances. During this process, some native assets (Ethereum, tokens or other cryptocurrencies) may also be sent to the user's wallet as gifts and to provide sufficient gas fees for future transactions. The SMS Wallet may also allow purchase of native assets using credit cards. However, such purchases should be exclusively handled in pop-up widgets by low-friction fiat-gateways (Transak, Simplex) with money-transmitter licenses, and the users must be promptly notified so.

The SMS wallet also provides the user a way to off-board when the user accumulates a meaningful amount of assets. In one click, the user may transfer all assets to a standard private-key based wallet such as MetaMask. The user will also be provided with an option to create a smart contract wallet (such as Phantom wallet) following a usual onboarding process, and transfer all assets there in one-click.

The presently disclosed SMS wallet is entirely focused on users, not creators. It aims for simplicity and ease of use, and presents a very opinionated, limited set of features to the user. The current disclosure should be distinguished from creator-oriented wallets which would focus on features such as sales management, NFT contract administration, and asset administration.

The present disclosure has the following main features. Core Security Features which includes creating a wallet and restoring a wallet. NFT acquisition which includes scanning a QR code and/or visiting a direct link. NFT acquisition may also be accomplished by claiming a free NFT(s). One example also includes the Purchase of NFTs using a credit card via a third party service (Stripe/Paypal). Therein also disclosed is a SMS controlled mini-wallet. The SMS controlled mini-wallet functions like an SMS wallet except the SMS controlled mini-wallet may be used in transferring native assets up to a certain amount to specific addresses and managing NFT assets. It is also contemplated that fiat gateway widgets for purchasing native assets that use Simplex and Transak may be used. Off-boarding of crypto assets may be accomplished to standard private-key based wallet. A specific example of a standard private-key based wallet includes 1 wallet.

Some prior art wallets operate on mobile cellular devices, however merely operating on a network is not equivalent to the present disclosure. Some wallets use 2FA otherwise known as 2 factor authentication in which a text message sent to a cellphone is used as a second source identifier for the legitimate user trying to log into an account. However 2FA methods that utilize SMS messaging are not secure due to sim card hacking.

In one embodiment a user may wish to use the current system to store a nominal amount of assets. Given the relatively insignificant amount of assets in the user's wallet, the mobile-browser runtime environment, the client computer may be assumed to be relatively secure and immutable. It is thus safe to store the wallet's private key as volatile, first-party cookies.

In the experience of the inventors, to prevent hacking and unauthorized access to the private keys, it is best to ensure the plain text private key (e.g. the cryptographic key represented as alphanumeric numerals) never leaves the mobile-browser environment. Users should also not be requested to make or retain any backup materials (such as seed phrases) that may derive the private key on its own, nor should any server be allowed to store or derive the private key either solely using the information available at the server.

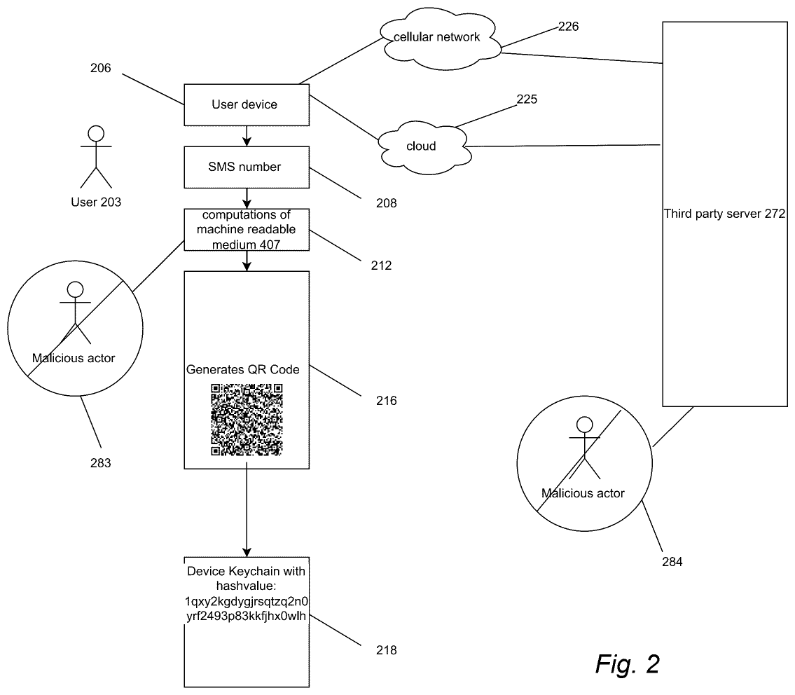

FIG. 2 shows an apparatus for securely distributing and recovering a wallet from a blockchain network via a cellular network comprising: at least one processor; storage to store instructions to direct at least one processor to generate a cryptographic wallet; a client side device and processor that generates private keys for a cryptographic wallet; sending the private keys generated by said client side processor to a keychain within the client side device; sending the private keys generated by said client side processor to a third party server.

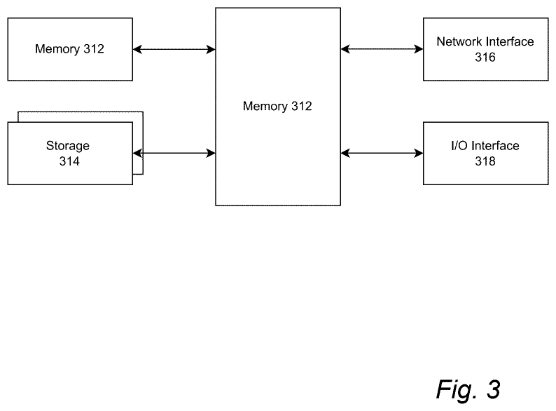

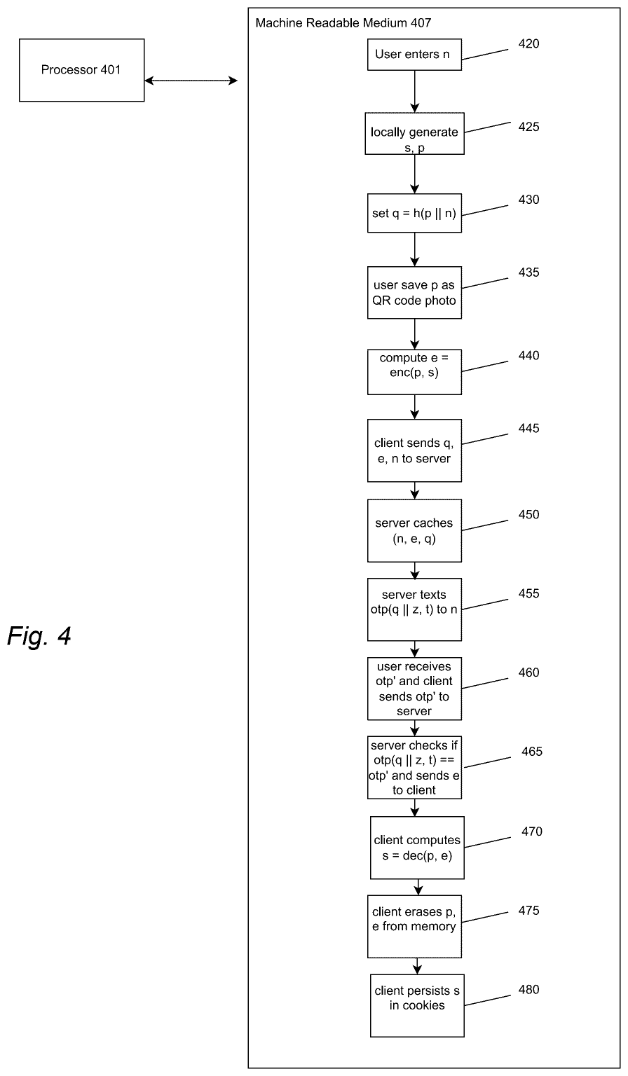

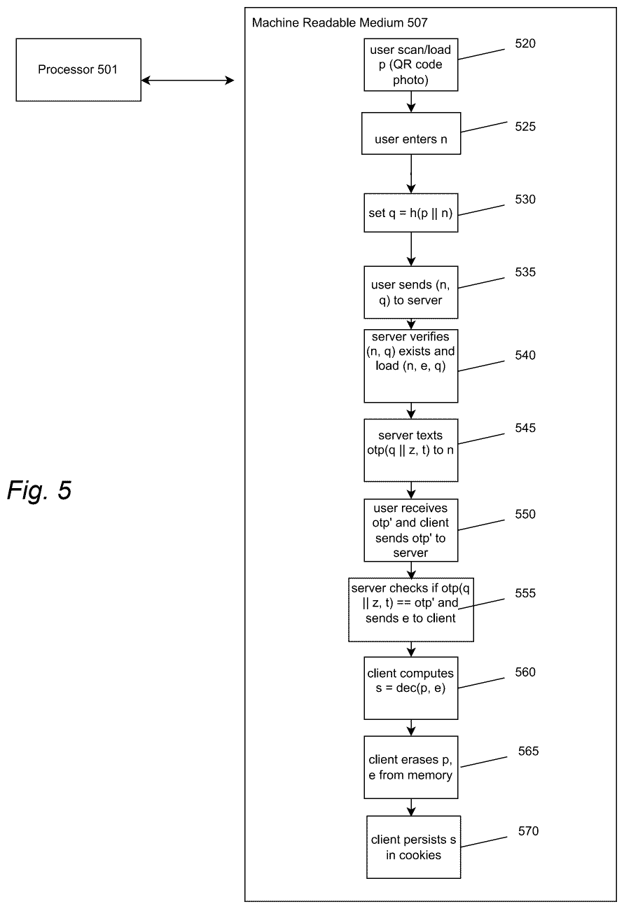

A more detailed look to FIG. 2 explains the above. A user 203 has access to a user device 206. The user device may be a mobile smartphone or computer. For purposes of the present discourse the user device will likely be a mobile smartphone but any computation device as further discussed in FIG. 3 will work. The user device will be associated with an SMS 208 number. The SMS number may be a telephone number as further described in this disclosure. At 212 the logic creating a smart wallet is performed. An example of an SMS wallet being generated can be seen in FIG. 4. An SMS wallet can also be recovered at 212. An example wallet recovery is shown in FIG. 5. At 216 a QR code from a private key is generated. This QR code may be stored on a device keyring, or where cookies are stored on the device. A device keyring is a secure storage area on a user's device that holds the cryptographic keys used by the wallet. It is typically part of the device's operating system security framework (such as iOS Keychain, Android Keystore, or a secure enclave/TPM). The keyring protects private keys by storing them in an encrypted, access-controlled location so that applications. In some examples a keyring may be used to store cookies.

At 218 a hashvalue (in the figure note the hash value stored is 1qxy2kgdygjrsqtzq2n0yrf2493p83kkfjhx0wlh) is stored on user 203's user device 206.

User device 206 may also send an SMS number via a cellular network 226. Cellular network 226 and the cloud 225 are two fundamental components of modern technology that play distinct but interconnected roles. Cellular network 226 enables wireless communication between devices such as 206, allowing people to connect with each other and access data on the go. They are infrastructure-based and provide coverage over a specific geographic area. In contrast, the cloud is a virtual storage and computing system that allows users to store and access data, applications, and services remotely. While cellular networks facilitate real-time communication and access to data, the cloud offers scalable and on-demand storage and processing capabilities.

Both cellular network 226 and cloud 225 rely on the transmission of data, but cellular networks focus on real-time communication, while the cloud focuses on long-term storage and computational resources. Additionally, cellular networks depend on physical infrastructure like cell towers, whereas the cloud relies on remote data centers and servers, making it highly scalable and accessible from anywhere with an internet connection.

User device 206 after Generating QR code 216 may also send the hashvalue of 218 to a third party server. This may be accomplished by utilizing cellular network 226 or the cloud 225. Third party server 272 may then store the hashvalue of 218, or a portion of the hashvalue. Though not part of the invention Malicious actor 283 and 284 illustrate why the disclosed invention is superior over standard 2FA. If malicious actor 283 compromises a user device by either stealing it or gaining remote access at the machine readable medium 212 level, a malicious actor still needs to find the QR code at 216 and the hash value saved at the device keychain at 218. Even if the actor obtains the data at 216 and 218, without input from third party server 272, the SMS wallet cannot be opened or send a transaction.

Additionally, even if malicious actor 284 gains access to third party server 272 without the device keychain hash value of 218, the malicious actor cannot send or receive funds or hashes from the SMS wallet. Contrast this with 2FA authentication in which if a user's smartphone is compromised and the user can send a signal from a phone, the user's wallet can be compromised. To compromise the present invention a malicious actor would need both access to a user's mobile device and a compromised third party server. For purposes of this disclosure a malicious actor is equivalent to a hacker, unauthorized user, or any agent without authorization from user 203 to use the user's SMS wallet.

FIG. 3 shows a potential apparatus that can be used to generate and interact with an SMS wallet. Memory 312 may store instructions for executing programs that run on a user device, a cellular network, the cloud, or other computation devices. Storage 314 may reform to long form storage such as a hard drive or short term storage such as RAM. Network Interface 316 may include the internet, cellular networks or the cloud. I/O interface 318 may be any piece of software that when run allows a user to interact with a device.

FIG. 4 shows an embodiment of creating a wallet using a user device. The following variables are used for FIG. 4: Variable “n” is the user's phone number, variable “z” is the server secret (transient) in 256 bit, “s” is the client generated private key in 256 bit, “p” is the client generated encryption secret in 256 bit, “h” is the keccak256 hash function. In certain implementations, the system may utilize a cryptographic hash function such as keccak256. As used herein, keccak256 refers to a member of the Keccak family of sponge-based hashing algorithms that produces a fixed-length 256-bit digest from an input of arbitrary size. The keccak256 function is designed to be computationally one-way, such that the original input cannot feasibly be reconstructed from the resulting hash, and further to be collision-resistant, meaning it is highly improbable for two distinct inputs to yield an identical digest. Due to these characteristics, keccak256 is well-suited for securely deriving identifiers, integrity checks, or cryptographic commitments within the disclosed systems and methods. “enc” is a symmetrical encryption algorithm (e.g. AES-CBC with p as initial vector)—here, enc(a, b) means to encrypt b using secret a, “dec” is the corresponding symmetrical decryption algorithm-here, dec (a, b) means to decrypt b using secret a, and “otp” is the time based one-time password (“TOTP”) algorithm-here otp(a, t) means to generate the TOTP for time “t” using “a” as the secret.

As utilized above and throughout the present disclosure computer-executable instructions may be expressed using conventional programming constructs. As used herein, a variable refers to a named data element that may store a value, such as a number, text, or cryptographic material. A function (also referred to as a routine, method, or subroutine) denotes a callable computational procedure that may receive one or more variables as parameters. Functions are commonly expressed with parentheses “( )”, which indicate the values or variables being supplied to the function for processing. Assignment of a value to a variable may be represented using an equal sign “=” or as written using the terms “setting” or “computing”, or any equivalent notation understood in the art. Logical operators may also be employed; for example, the double-pipe symbol “∥” is commonly used to represent a logical OR operation in many programming languages, or the double equal signs “==” is used as a comparison operator that evaluates whether two values are equal. Cryptographic secrets or keys referenced herein (including server secrets, private keys, or encryption secrets) may be represented as binary values of arbitrary length, and in some implementations may comprise 256-bit values, corresponding to a sequence of 256 binary digits used for secure cryptographic operations. These generalized definitions are provided solely for clarity and are not intended to limit the scope of this disclosure to any specific programming language, syntax, or implementation.

It should be understood that the programming constructs and symbolic representations described herein are intended to be language-agnostic, and a wide variety of computer programming languages and syntactic conventions may be used. Differences in syntax, structure, and library support across languages do not materially affect the underlying logical operations described. Numerous technology stacks may be employed to realize the disclosed systems and methods. By way of non-limiting example, a standard REST-based application server may be used, such as an implementation written in Node.js; server-side data persistence may utilize a private datastore accessible exclusively by the server, such as a managed storage system (e.g., a cloud-based datastore). A client interface may be delivered through a web application written in JavaScript using frameworks such as React. In certain implementations, components of the client host may be deployed on content-addressed or immutable hosting platforms, including but not limited to distributed file systems such as IPFS. These examples are illustrative only, and the invention contemplates the use of any suitable programming language, framework, runtime environment, or hosting architecture capable of performing the described operations.

It should be further noted in the experience of the inventors the following components may be used: a standard REST API server, e.g. in node.js a private database that is accessible only by the server, e.g. GCP Datastore a web client, e.g. written in Javascript with React a client host, ideally immutable, e.g on IPFS.

At 420 the user enters an SMS phone number via a client device or computer when prompted by a user interface to initiate the generation of an SMS wallet. Phone numbers are numerical addresses assigned to telephones and other communication devices to establish a unique identity for each device on a telecommunications network. Phone numbers are used to enable voice calls, text messaging, and other forms of communication between individuals and entities. Phone numbers serve as a unique identifier for each telephone line or device on a telecommunications network. They are crucial for directing calls and messages to the intended recipient. Phone numbers may be represented as a sequence of digits. The format and length of phone numbers can vary from country to country. For example, in the United States, a typical format is (XXX) XXX-XXXX, while in some other countries, phone numbers may have a different structure. The SMS number may be imputed by a user or gleamed from cellular network 226.

At 425 a processor is used to generate a client generated private key “s” in 256 bit and a client generated encryption secret “p” in 256 bit. The keys are 256 bits meaning the length of the encryption key in bits is 256. A longer key typically results in a stronger level of security. In this case, the key used for encryption and decryption is 256 bits long. The encryption key may also be a sequence of 256 binary digits (0s and 1s). This key is used in combination with an encryption algorithm to scramble and protect data. More algorithms will be discussed below. For example at 430 the keccak256 hash function may be used.

At 435 the user's encryption key may be saved as a QR code photo. Saving the key as a QR photo is superior to prior art saving as text for several reasons. For one, if a user's smartphone is compromised via malicious software, QR codes are harder to search for on the file system of a device than are strings of text (strings of encryption keys). A hacker can find a string of text for an encryption key faster than they can search for photos one by one via a device. Additionally, a user will have an easier time finding a QR code on a phone than searching for a string of numbers making an encryption key, especially if the user is unfamiliar with blockchain technology.

At 440 a processor is used to compute “e” via the function enc(p, s). Here, the variable “e” is defined by the value produced by the function “enc” which received the parameters “p” and “s”. “enc” is a stored function on the program. At 445 the client computing device then sends the variables “q”, “e”, “n” to a server. At 450 the server receives the variables and then caches the variables (n, e, q). At 455 the server utilizes the function otp(q∥z, t) to generate otp′. The value otp′ is texted to the number stored in variable “n”. At 460 a user receives otp′ and the client device sends otp′ to back to the server. At 465 the server checks if otp(q∥z, t)==otp′. In other words, the server checks if the function otp(q∥z, t) is equivalent to otp′. If the two values are equivalent, then the server sends the variable “e” to the client device. At 470, because the client computer has the value of “e” the client computer computes the value to s via the function “dec”, providing the variables “p” and “e” to the function, such as s=dec(p, e). At 475 the client erases the values for “p” and “e” from memory. At 480 the value for s persists in memory but as a cookie.

A “cookie” in the context of the above is a small piece of data that is stored on a user's computer or device when they interact with a website or web application. Cookies are not standalone software; they may be small text files that serve various functions related to user experience, website functionality, and tracking. A novel point of the present disclosure is that a cookie is being used to store a portion of a hash function that will later be used to restore a user's cryptographic wallet.

Along with generating a wallet, the user can also restore the wallet by using cryptographic keys both stored on a user's device, and with a server away from the client's device. Turning to FIG. 5 there is a processor 501 in communication with a machine readable medium 507. It should be noted the processor working with machine readable medium may be a server located away from a user's own mobile device, or a mobile device itself. At 520 a user may scan a QR code for a portion of an encryption key. Along with scanning, the mobile device's own software may also be able to gather the information found within the QR code. The portion of the encryption key retrieved from the QR code is then loaded into variable “p”. At 525 a user is prompted to enter a telephone number. It should be noted that sometimes the telephone number may be auto populated by the mobile device itself, or the telephone number may be shared via a mobile device's own operating system. At 530 a computation is performed in which “q” is determined by the function “h” receiving the variables “p” and “n” such as in q=h(p∥n). Function “h” being the hash function which received the parameters “p” and “n” to set value q. Once q has been determined the values q and n are sent to a server 535. At 540 a server must verify the values of n and q by performing computational checks utilizing the received variables and previously cached variables (n, e, q). After verifying n and q, the server loads the values “n”, “e”, and “q”. At 545 the server utilizes the function otp(q∥z, t) to text the value otp′ computed to the number stored in variable “n”. At 550 a user receives otp′ and client sends otp′ to the server. At 555 the server must check if two values are the same. The server performs this computation by the following server checks if otp(q∥z, t)==otp′ and sends e to client. At 560 the client computer computes the function “dec” using variables “p” and “e” such as in s=dec(p, e). At step 565 the client device erases “p”, “e” from memory. This is a crucial step because a majority of crypto wallets will end up storing the p and e in memory. This deters from security because it allows a vulnerability in the system for hackers or other nefarious actors to gain access to private keys. At 570 the client persists s in cookies. Unlike storing keys in regular memory as discussed above, by storing the keys, or at least a portion of the keys as a cookie greater user security is achieved.

For one, cookies are usually stored on the hard drive or permanent storage of a user's device. A cookie's content, appearance, and data can also be hidden from unsophisticated users due to the code's unique appearance. Cookies may be stored in several ways. For some web browsers a file called “Cookies” may be used to store the data for the keys. Example directories for cookies include the following:

| Platform | Directory |
|---|---|
| Web | C:\Users\<username>\AppData\Local\Google\Chrome\User Data\Default |
| browser | |
| (sql) | |
| Web | C:\Users\<username>\AppData\Roaming\Mozilla\Firefox\Profiles\<profile_folder> |
| browser | |
| (php) | |
| Web | C:\Users\<username>\AppData\Local\Microsoft\Edge\User Data\Default |
| browser | |
| (sql) | |
| macOS | /Users/<username>/Library/Application Support/Google/Chrome/Default |
| browser | |
| macOS | /Users/<username>/Library/Application Support/Firefox/Profiles/<profile_folder> |
| browser | |
| macOS | /Users/<username>/Library/Cookies/Cookies.binarycookies |
| browser | |

The present disclosure is superior to conventional methods of securing a cryptographic wallet because a hacker must compromise both a user's phone and third party server to gain unauthorized access to a wallet. Even if a hacker or malicious actor obtains a user's phone via physical contact or sim card swapping, if the hacker does not have access to the data within a QR code, an attempted 2FA will not work. A few illustrations can explain this point. If the user's saved QR code (photo) is stolen, the hacker cannot obtain the user's private key without getting a copy of the user's encrypted private key e. The hacker cannot obtain the user's encrypted private key e unless the hacker also compromises the user's phone or is able to intercept the user's text messages.

Even if a hacker somehow compromises the server, the hacker will only have obtained “e”. This means the hacker still cannot access a user's wallet because the hacker cannot obtain any user's private key(s) without first obtaining the user's encryption secret p, which is stored locally as a photo in the user's device. The hacker cannot obtain p by intercepting traffic at the server or sending malicious responses to the user because p is not on the server and sending a malicious response would require malware to know the specific location on a user's device where p is stored.

The only way for the hacker to obtain p (other than to steal it from the user or user's device directly) is to also compromise the client (e.g. via phishing or a sim card swap attack) and intercept p when a user wants to restore their wallet. In the experience of the inventors, to reduce such risk, the client should be served by isolated infrastructure (e.g. IPFS or others), and not be served using the same server.

The acquisition of NFTs and other cryptographic hashes to a user's wallet is also enhanced by the current disclosure. NFT acquisition can be implemented with or without the involvement of a server. The approach without a server requires a third party server to provide a small amount of native assets upfront to newly created wallets as gas fees for client-initiated transactions. This approach is more “decentralized” but has many implicit limitations. For example, the third party server cannot easily rate-limit the number of claims a wallet might make across NFTs from multiple contracts. In the case of supporting credit card purchases, a server has to be used to reliably verify the status of a credit card transaction before a (paid) NFT can be delivered to a user. For these reasons, a server based implementation is more advantageous in terms of simplicity, functionality, and reusability.

Sending NFTs and other cryptographic hashes to a user's wallet is also possible with the current disclosure. NFT acquisition can be implemented with or without the involvement of a server. The approach without a server requires an operator to provide a small amount of native assets upfront to newly created wallets as gas fees for client-initiated transactions. This approach is more decentralized but has many implicit limitations. For example, a third party server cannot easily rate-limit the number of claims a wallet might make across NFTs from multiple contracts. In the case of supporting credit card purchases, a server has to be used to reliably verify the status of a credit card transaction before a paid NFT can be delivered to a user. For these reasons, a server based implementation is more advantageous in terms of simplicity, functionality, and reusability.

The present disclosure can also be used to send NFTs. From the view of a server, the process of serving a request to claim free NFTs is not different from the process of honoring an NFT purchase via credit card. Once the server confirms which NFT is to be sent to the user, all that remains is to deliver the NFT to the user's wallet. Some appropriate delivery methods include the following. To execute a (custom) mint function on the NFT contract with a destination address set to the user's address. To execute safeTransferFrom, the standard transfer function of ERC721 or ERC1155 that moves the ownership of the pre-minted NFTs to the user.

A suitable method for implementation, a separate server with a dedicated private key (and wallet address) can be used to facilitate the transfers when users claim or purchase NFTs. The following preparations should be done prior to enabling NFT claims or purchases for each NFT contract. Here, we refer the NFT contracts' admin(s) as Creators: Creators should mint some NFTs ahead of time, and specify which ones are claimable (as free NFTs), and which ones are purchasable and at what price. For example, at 607 an admin mints an NFT or a set of NFTs. This requires generating several cryptographic hashes that are eventually published to a blockchain network. Creators should register the NFT contracts, token IDs, and fiat prices with the server 612. Creators should transfer the minted NFTs to a separate wallet address (“Vault”) controlled by the Creators. Creators should approve the server's wallet address to operate the tokens in the Vault (use **setApprovalForAll** or **approve** functions in the standard). When the server processes a request for claiming free NFTs, the server should verify the user's phone number (using SMS and OTP) before proceeding with executing the transfer function on the NFT contract. The server should integrate Stripe or Paypal credit card purchase APIs and callbacks. When the server processes a purchase, it would wait for the appropriate callback from Stripe or Paypal to trigger, before looking up the purchased NFT, and the user's phone number and wallet information before sending the NFT to the user using the same transfer function.

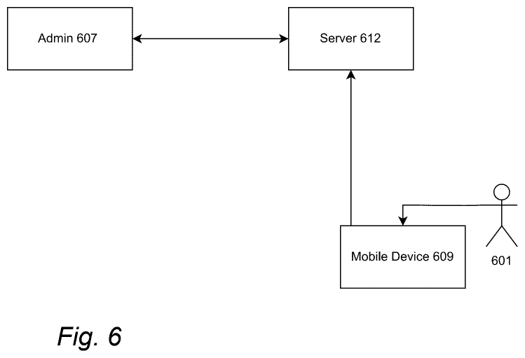

The setup in FIG. 6 ensures in the worst case that the server's private key is completely compromised, the only NFTs at risk would be the ones transferred to the Vault which the creators explicitly approved the server to control. Usually, this only includes a small amount of NFTs in a single round of sale. This setup effectively prevents catastrophic incidents when a creator's entire collection is stolen by hackers, or to have the entire contract under control by the hacker.

Using an SMS enabled wallet grants superior security to a user over the prior art for several reasons. Broadly speaking, there are two types of SMS commands concerning the user's wallet. The first (type I SMS command) are commands that do not require the user's authorization, for example, claiming an NFT. These commands can be completed by the server initiating a blockchain transaction for the benefit of the user. The second (type II SMS command) are commands that require the user's express authorization, for example, transferring X amount of native asset to address Y, transferring an NFT A to address Y, approving address Y to operate NFT. Usually, the express authorization is manifested by the user “signing the transaction”, i.e. using the private key to encode a JSON RPC request with transaction data.

For type I SMS commands the server can simply execute the required transaction using its own private key, after the server receives a callback from SMS gateways (such as Twilio) that contains the user's SMS commands. For type II SMS commands a more complex processing system is utilized. Here, any express authorization from the user can only be given by text messages in English, and the user's private key is unobtainable throughout the process. Therefore, to achieve this functionality, it is inevitable that the server gains custody of some of the user's assets. To minimize security risks, the scope and size of operations the server is permitted to perform with respect to any user's asset should be limited and configured by the users themselves.

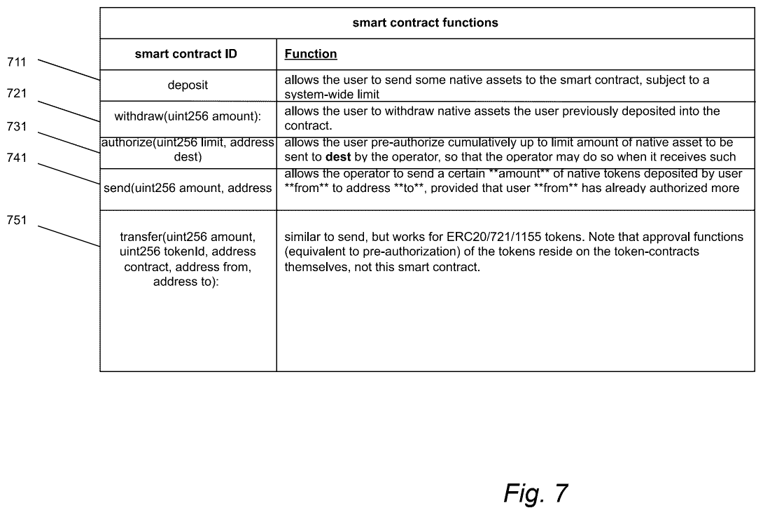

One way to minimize security risks when using a public blockchain is through utilizing a smart contract with the functions disclosed in FIG. 7. These functions are discussed more below. For example, at 711 there is a smart contract ID for deposit. Deposit allows the user to send some native assets to the smart contract, subject to a system-wide limit. At 721 there is a smart contract ID withdraw (uint256 amount) which allows the user to withdraw native assets the user previously deposited into the contract. At 731 there is a function authorize (uint256 limit, address dest) which allows the user pre-authorize cumulatively up to limit amount of native asset to be sent to dest by the operator, so that the operator may do so when it receives such SMS commands from the user. At 741 there is a function send (uint256 amount, address from, address to) which allows the operator to send a certain **amount** of native tokens deposited by user **from** to address **to**, provided that user **from** has already authorized more than such **amount** of native tokens and the limit is not used up. At 751 there is a function transfer (uint256 amount, uint256 tokenId, address contract, address from, address to) which is similar to send, but works for ERC20/721/1155 tokens. Note that approval functions (equivalent to pre-authorization) of the tokens reside on the token-contracts themselves, not this smart contract. Note the contract may also maintain some read-only functions and public variables to allow pre-authorization and deposit information to be looked up by the users and the operator.

The current disclosure also allows for a user to offload funds from an SMS wallet to a different wallet. For example, a user may transition from the SMS wallet to a browser or plugin wallet. If the user is on desktop, the browser page could guide the user to install MetaMask then invoke eth_request Accounts on the web3 provider to obtain the user's MetaMask address. After that, the client could submit multiple transactions that transfer all assets to the MetaMask address, pending the user's final confirmation. The whole process can be completed in two clicks on the web page (one click to connect MetaMask, one click to provide confirmation), plus a few clicks on the MetaMask extension.

If the user is on mobile, the browser page could use a deep link that automatically opens MetaMask mobile app and loads a custom, unique URL in the in-app browser. The script at the URL will capture the user's MetaMask wallet address and rewrite the URL, then instruct the user to open the current page in-browser (using the “ . . . ” button on the bottom right). After the user opens the page in the browser, the transfer of assets can continue in the same way compared to the desktop case.

If the user is on desktop, the browser page could show a wallet-connect QR code to begin a wallet-connect session. Most private-key wallets support wallet-connect. After the session is established, the browser page could obtain the user's destination wallet address and continue the same way as described in MetaMask desktop case.

As discussed previously, the Core Security Features may also be used for a wallet which primarily uses email for authentication. In that case, the verification codes can simply be sent to email addresses instead of phone numbers, and the encrypted key of a user is bound to an email address. However, a few key differences should be noted. First regarding email, since email is much easier and much cheaper to obtain than a phone number, the risk of bots and spam becomes significantly higher. Certain strategies that make sense for users who verified their phone numbers may become problematic for users who only verified their email addresses. For example, the proposal that allows users to claim free NFTs, or the one that provides a small amount of native assets for newly registered users. Email-only verification makes it very easy for someone to abuse the system as long as there is an incentive to do so.

Second, Email is not as interactive as text. In fact, it is almost unheard of that any user would expect to reply back to an email to confirm a transaction, or to send a command to a certain email address to initiate any action. Most users expect emails to be read and processed by humans. Therefore, we cannot simply replace “SMS Controlled Mini-wallet” by “Email Controlled Mini-wallet”. The mini-wallet design might not work at all in the case of email, despite the fact that we have the ability to generate a unique recipient email address for each user. There is an inherent risk of sender-email address spoofing, and people may write emails in many different languages, formats, encoding, or signatures. Third, Email is a great tool to display rich content and to follow-up with customer support conversations, subscription content, or interesting statistics. SMS cannot do that.

SMS Wallets may be used to sign arbitrary transactions as well. Consider a game that needs an SMS Wallet user to approve a smart contract transaction. The game could call an API which SMS Wallet backend may provide. The backend would create a compressed, unique URL mapped to the user's wallet address and the transaction, then text the URL to the user's phone number. The user may click the URL in a text message, and confirm signing in the browser (which has access to the wallet's private key as the URL would share the same domain).

A third party application uses an SMS Wallet API to create a unique link to the third party application site. This link has contract data, destination, source address, success callback URL, and failure callback URL all pre-populated. If the user is then sent to the server site a processor can perform logic to determine which of the following has occurred. Option 1: if logged in, given the option to approve or deny the transaction. Option 2 user is not logged in. If Option 2 occurs: 1) user receives a text message from us, providing the TOTP code 2) User clicks link containing code 3) Complete the restoration process by uploading ‘p’ via QR code 4) User is now logged in and presented approve/deny options same as 2a. The act of approving the transaction signed the specific transaction with ‘s’, the user's private key. The complete signature is transmitted to our server. Our server re-transmits the signature to a network of distributed computers for verification and execution.

It should be noted that the SMS wallet can be used simultaneously and independently on both the user's phone and computer. The user may simply restore the wallet on a desktop computer after they created it on the phone. The usage flows are identical. Additionally, a third party server may allow a user to “logout” from the browser at any time. The client would delete all the cookies, hence the private key cached in the browser. Similarly, we may call “restore” as “login” instead. For extra security, the apparatus may have the option to reduce cookies expiry time, or not to store the private key in the cookies at all. In that case, the apparatus would require the user to retrieve the encrypted private key from the server every time the user wants to make any transaction, hence forcing the user to verify the phone number with an OTP code every time, essentially turning the SMS Wallet as a 2FA wallet using SMS as the secondary factor for security.

Once the wallet has been generated it can also be restored using the presently disclosed apparatus and system. Because all interactions are on a blockchain, an individual user's ranking can be independently computed and verified. This is very different from typical centralized approaches to reward programs that can often be gamed or wholly manipulated by the controlling entity. Proof of attendance and participation with a specific artist or venue can be verified by checking data published to a blockchain from the SMS wallet. For instance, fan purchases physical inventory, a concert ticket, experience from artists, attending concerts at a specific venue is published to the blockchain. This is because an NFT with this data may be viewed on a blockchain the SMS wallet uses. Prior art and other Web2.0 are less superior to the currently disclosed SMS wallet because prior art solutions for ticketing often involve email capture and digital tickets that become essentially useless after they are scanned. For example, some Web2.0 social networks track likes and connections but do not leverage the interactions between connections. A more specific example can illustrate this point. If Fan A bought more merchandise and went to more shows (purchased more tickets) than Fan B, Fan A is ranked higher than Fan B on the Artist's profile's list of followers). The present disclosure turns the tickets and creator/fan, venue/patron interactions into verifiable pieces of data stored on a blockchain. It also adds tangibility to a “digital” asset because the data involving purchases of physical objects (T-shirts, mugs other merchandise) is stored on a blockchain.

Tangibility is added to digital assets by the following. First each interaction is recorded and stored with the wallet. Proof of attendance and participation with a specific artist or venue is recorded. For instance, fan purchases physical inventory, a concert ticket, experience from artist, attends concerts at a specific venue, etc.

An acceptable fan ranking algorithm includes the following. To create a novel way to rank fandom based on the time being a fan and “fan actions,” you can use a weighted formula to consider both factors. The following is an example algorithm that balances these two variables. Variables: TT=Time being a fan in days, AA=Total number of fan actions (attending shows, buying merch, etc.), W1W1=Weight given to the time factor (between 0 and 1), W2W2=Weight given to the fan actions (between 0 and 1), NN=Normalization factor for fan actions (to make it comparable to TT). Note: W1+W2=1W1+W2=1 to ensure that both weights sum to 100%. A potential equation includes.

$$Fandon Rank ( FR ) = W 1 \times T + W 2 \times ( A \times N ) Fandom Rank ( FR ) = W 1 \times T + W 2 \times ( A \times N ) .$$

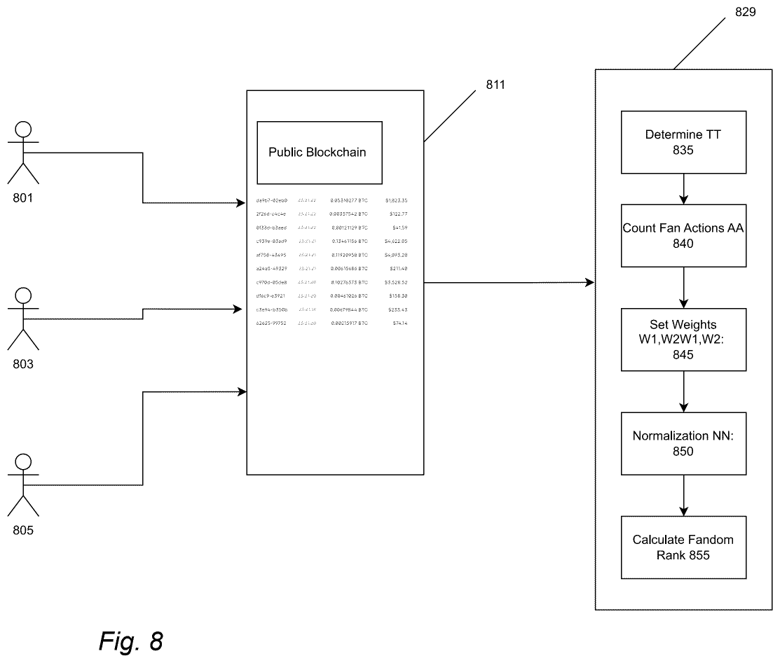

FIG. 8 gives a more detailed overview of the ranking fans using the SMS wallet. At least three users such as user 801, user 803, and user 805 may download and use an SMS wallet on a mobile or other computing device. The transactions from the user are then recorded to a public blockchain 811. The data from the public blockchain can be sent to and read by server 829. With the data from the blockchain to Calculate the time each fan has been a fan in days at 835. At 840 AA can be calculated by tallying up the number of fan actions like attending shows, buying merchandise, or other actions designated to be fan actions. At 845 the server can decide the weights to give each variable. For instance, W1-0.6W1-0.6 and W2-0.4W2=0.4 would give more importance to the time being a fan. At 850 a server may choose a normalization factor to scale fan actions in a way that makes them comparable to the time being a fan. For example, if 1 fan action is deemed as impactful as being a fan for 10 days, N=10N=10. Finally at 855 Calculate Fandom Rank Use the equation to find the Fandom Rank (FR) for each fan.

An example illustration can be used to walk through FIG. 6. Suppose a user has been a fan for 100 days (T=100T=100) and the user has taken 5 fan actions (A=5A=5). If W1-0.6,W2-0.4,N=10W1=0.6,W2=0.4,N=10, then:
FR=0.6×100+0.4×(5×10) FR=0.6×100+0.4×(5×10) FR=60+20FR=60+20FR-80FR=80. This is a simplified example and it could extend the formula to include more variables, such as social media engagement, to get a more comprehensive Fandom Rank.

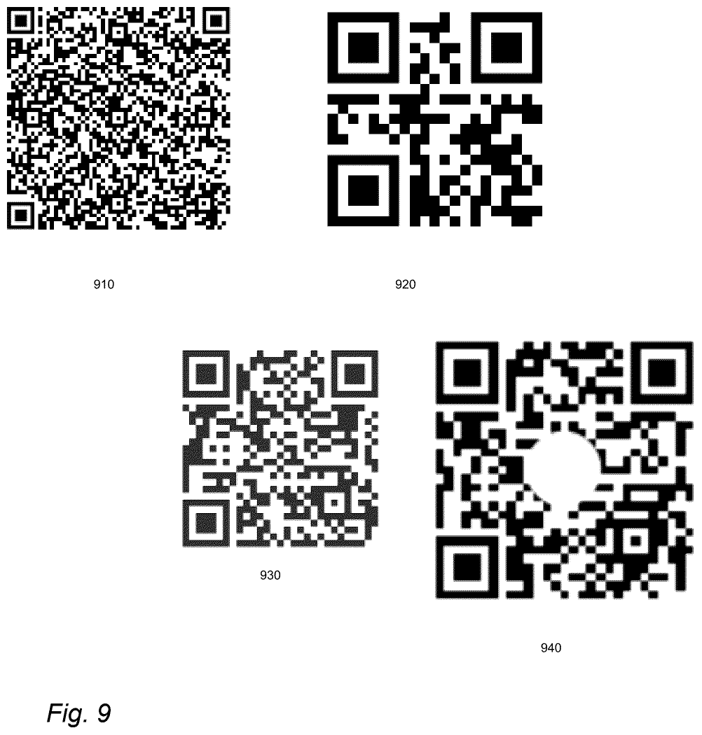

FIG. 9 is an example QR code that contains a private key and/or data stored on a user device 609 in FIG. 6. QR codes may also be stored on a keychain. The QR code can also store messages, crypto public keys (such as 0x35EAb177bEF1e6a9c6cc048Acf687B720fF88120), and private keys. Another potential address is: 0x00424643f38d81461a093ecb46a37e127a0b81b1.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An system for securely distributing and recovering a wallet from a blockchain network via a cellular network comprising:
a first processor;
a first storage to store instructions to direct at the first processor to generate a cryptographic wallet on a web browser using a user's SMS number;
a client side device having a second processor that generates private keys for a cryptographic wallet, the second processor sending at least one portion of the generated private keys to a keychain within the client side device, and at least one portion of the generated private keys to a third party server;
wherein after the user initiating a wallet recovery via the client side device causes the second processor to retrieve the portion of the private key from the SMS wallet from the third party server and combine it with the portion of the private key stored on the keychain of the user device to restore the SMS wallet.

2. The apparatus of claim 1 wherein the second processor is configured to send the private keys to a keychain within the client side device via a QR code.

3. The apparatus of claim 1 wherein the private keys are stored as a hashvalue on the keychain.

4. The apparatus of claim 1 wherein the private keys are stored as a cookie on the user's device.

5. The apparatus of claim 1 wherein the SMS wallet is restored by sending at least one portion of the private keys from the third party server to the user device via the cloud or cellular network.

6. The apparatus of claim 1 wherein the SMS wallet is limited to engage in smart contract functions comprising deposit, withdraw, authorize, send, transfer.

7. The apparatus of claim 1 wherein sending the private keys to the keychain of the user device further comprises, the user entering their SMS number and the second processor assigning the number to variable n.

8. The apparatus of claim 7 wherein the second processor locally generates values s and p, then sets value q via function h(p∥n), the second processor saves p as a QR code photo on the client device and computes value e via function enc(p, s) and sends the values q, e, n to the third party server wherein the third party server caches values n, e, q.

9. The apparatus of claim 8 wherein the third party server texts otp′ to SMS number stored in the value n and the user receives otp′ to then send otp′ back to the third party server, the third party server checks if otp(q∥z, t)==otp′ and sends e to the client device, the second processor of the client device then computes value s via function dec(p, e), erases p, and e from memory and persists s in cookies on the client device.

10. The apparatus of claim 1 wherein the wallet recover further comprises the user scan/load value p via a QR code photo the second processor prompting the user to enter n wherein once n is entered the second processor sets value q via the function h(p∥n), the user sends values n and q to the third party server which verifies values n and q exists and loads values n, e, and q, the server texts otp′ to n, the user receives otp′ and client sends otp′ to server, server checks if otp(q∥z, t)==otp′ and sends e to client device, the second processor of the client device computes value s via function dec(p, e), client erases p, and e from memory, client persists s in cookies.

11. A method of reducing the effectiveness of hacks from a malicious actor on an SMS wallet comprising:
providing at least one processor with instructions stored on a storage to direct the at least one processor to generate an SMS wallet on a user device;
generating an SMS wallet by using a user's SMS number by a second at least one processor of the user device to generate a private key;
storing at least one portion of the private key as a QR code on the user's device;
sending at least one portion of the private key to a third party server via a cellular network;
upon the user initiating the wallet recovery causing the second at least one processor of the user device to retrieve from the third party server the stored portion of the private key and combining the stored portion of the private key on the QR code on the user device to restore the SMS wallet.

12. The method of claim 10 wherein the SMS wallet is restored by sending at least one portion of the private keys from a third party server to the user device via the cloud or cellular network.

13. The method of claim 10 wherein the SMS wallet is limited to engage in smart contract functions comprising deposit, withdraw, authorize, send, transfer.

14. The method of claim 10 wherein the private keys are stored as a hashvalue on the keychain and third party server.

15. The method of claim 10 wherein the private keys are stored as a cookie on the user's device.

16. The method of claim 1 wherein the SMS wallet is limited to engage in smart contract functions comprising deposit, withdraw, authorize, send, transfer.

17. The method of claim 1 further comprising the steps of sending the private keys to the keychain of the user device further comprises, the user entering their SMS number and the second processor assigning the number to variable n, the second processor locally generating values s and p, setting value q via function h(p∥n), the second processor saving p as QR code photo on the client device and computing value e via function enc(p, s) and sending the values q, e, n to the third party server wherein the third party server caching values n, e, and q, the third party server texting otp′ to SMS number stored in the value n and the user receiving otp′ and sending otp′ back to the third party server, the third party server checking if otp(q∥z, t)==otp′ and sending e to the client device, the second processor of the client device computing value s via function dec(p, e), erasing p, and e from memory and persists s in cookies on the client device.

18. The method of claim 1 wherein the wallet recovery further comprises the steps of the user scanning the QR code photo and loading value p via the second processor, the second processor then prompting the user to enter n wherein once n is entered the second processor sets value q via the function h(p∥n), the second processor sending values n and q to the third party server which verifies values n and q exists and loads values n, e, and q, the server texting otp′ to n, the user receiving otp′ and second processor sending otp′ to the third party server, the third party server checking if otp(q∥z, t)==otp′ and sending e to client device, the second processor of the client device computing value s via function dec(p, e), and erasing p, and e from memory, and persists s in cookies.
